(19) United States
(12) Patent Application Publication
(10) Pub. No.: US 2026/0351559 A1
(43) Pub. Date: Nov. 5, 2026

(54) PROCESSES FOR FABRICATING ZINC ION HYBRID SUPERCAPACITORS, ZINC-SULFUR AND MICRO ZINC-ION ENERGY STORAGE DEVICES

(71) Applicants: The Texas A&M University System, College Station, TX (US); ATSP Innovations Inc., Houston, TX (US)

(72) Inventors: Andreas A. Polycarpou, College Station, TX (US); Ahmad Amiri, College Station, TX (US); Louis Vaught, College Station, TX (US)

(73) Assignees: The Texas A&M University System, College Station, TX (US); ATSP Innovations Inc., Houston, TX (US)

(21) Appl. No.: 19/123,653

(22) PCT Filed: Oct. 26, 2023
(86) PCT No.: PCT/US2023/036014

§ 371 Date: Apr. 23, 2025

Related U.S. Application Data
(60) Provisional application No. 63/419,704, filed on Oct. 26, 2022.

(51) Int. Cl. H01M 4/24; H01G 11/04; H01G 11/34; H01G 11/56; H01G 11/68; H01M 4/66; H01M 10/26; H01M 10/28

(52) U.S. Cl. CPC H01M 4/244; H01G 11/04; H01G 11/34; H01G 11/56; H01G 11/68; H01M 4/663; H01M 10/26; H01M 10/28; H01M 2300/0085

(57) ABSTRACT

Processes for fabricating zinc-ion and zinc-sulfur energy storage devices are disclosed. In son aspects, a rechargeable, multifunctional quasi-solid-state zinc-sulfur battery includes sulfur-added carbon substrates, with particulate and porous carbon nanofibers as the cathode material and an anti-freezing hydrogel electrolyte coating. In son aspects, a flexible energy storage device comprises zinc-ion hybrid MEMS supercapacitors, with high areal energy density and remarkable flexibility that allows them to bend without compromising structural integrity.

### CROSS-REFERENCE TO RELATED APPLICATIONS

This patent application claims priority from, and incorporates by reference the entire disclosure of, U.S. Provisional Application No. 63/419,704 filed on Oct. 26, 2022.

### STATEMENT REGARDING FEDERALLY SPONSORED RESEARCH

This invention was made with government support under HQ072721P0028 awarded by the Department of Defense. The government has certain rights in the invention.

### TECHNICAL FIELD

The present disclosure relates generally to batteries and more particularly, but not by way of limitation to, zinc-sulfur batteries and their use as structural energy storage devices and as flexible energy storage devices.

### BACKGROUND

This section provides background information to facilitate a better understanding of the various aspects of the disclosure. It should be understood that the statements in this section of this document are to be read in this light, and not as admissions of prior art.

The development of various electric devices, including electric vehicles (EVs), electric airplanes (AEA), and electronics, has accelerated and pushed the market toward alternative electrochemical energy storage with system-s level higher energy density than state-of-the-art Li-ion batteries (LIBs). Recent efforts to improve the energy density at the systems-level (the scale of the vehicle) can be classified into two categories: (i) Innovations in LIBs and also development of alternative rechargeable batteries with higher energy density than LIBs, such as lithium-sulfur (Li—S) batteries, and (ii) development of multifunctional electrode materials (structural energy storage devices) with simultaneous load-bearing and energy-storing capabilities to attain weight savings on a system level. Unlike traditional energy storage devices, e.g., LIBs and supercapacitors (SCs), structural energy storage carries external loads. Therefore, different components of electric vehicles (car bodies), unmanned aerial vehicles (wing panels), air taxis (wing panels), etc., can be replaced with structural energy-storing components. This is a promising alternative for producing efficient generations of unmanned aerial vehicles, aircraft, or car body panels, aiming to save weight or volume. In addition, the mechanical integrity of electronics relies heavily on the packaging frames to protect the passengers from unintended battery discharge for instance in the event of the crash. The load bearing capability of structural energy storage devices can reduce the weight of the packaging frames, leading to batteries with an effectively higher energy density.

Along these lines, different structural energy materials with good electrochemical and mechanical properties and high specific surface area (SSA), such as carbon nanofibers (CNFs), graphene, carbon nanotubes (CNTs), aramid nanofiber (ANFs), Kevlar fiber, etc. have been used to manufacture mechano-electrochemically-efficient energy materials. The majority of efforts, especially on supercapacitors, reported outstanding mechanical properties and long electrochemical lifetime; however, the energy density of state-of-the-art structural batteries and supercapacitors (~1-30 Wh/kg) is behind current operational values (>200 Wh/kg) for applications such as EVs and electronics.

The introduction of structural energy storage into emerging markets, such as electric vehicles, is predominately hindered by weak energy density, safety concerns, and immaturity of the field in materials. Metal-sulfur (M-S) batteries possess extremely-high energy density, cost-effective electrodes, and nontoxicity, indicating tremendous capability for next-generation electrochemical energy storage. Nonetheless, due to technical limitations, timely progress has not been made until the past decade. In addition, a metallic electrode in its sandwich-like structure is capable of sustaining loads, representing a great candidate for next generation of structural energy storage. Among M-S batteries (lithium/sulfur (LiS), sodium/sulfur (NaS), magnesium/sulfur (MgS), and aluminum/sulfur (AlS) batteries), the LiS batteries are highly inflammable and raise safety concerns. In addition, high maintenance costs and safety hazards of NaS batteries are the main functional constraints of this kind of energy storage, even as a conventional energy storage device. Moreover, the MgS and AlS batteries suffer from strong polarity caused by Mg²⁺ and Al²⁺, respectively, resulting in energy barriers and short lifespan. These problems may be solved in by continuously optimizing these systems and exploring novel metal/sulfur systems.

On the contrary, ZnS batteries offer favorable electrochemical properties such as high theoretical volumetric (5,584 mAh/cm³) and gravimetric capacities (819 mAh/g), low electrochemical potential (−0.76 V vs SHE), non-toxicity, non-flammability, safety, and low cost. Besides, the reported theoretical and empirical energy density values for ZnS battery are >300 Wh/kg, showing a great promise toward representation across a new generation of multifunctional devices. For instance, a nonstructural Zn/carbon nanotubes supported 50 wt % sulfur battery has been fabricated and was able to achieve a high capacity of 1,105 mAh/g and an energy density of 502 Wh/kg. A ZnS battery has also been developed with outstanding energy density of 724.7 Wh/kg, excellent lifespan of over 1,600 cycles. In addition to energy density gains mentioned above, for structural energy storage to be employed in applications such as EVs, factors such as electro-chemo-mechanics of electrodes, temperature, and safety, have not been adequately addressed so far to assess their market potentials. Insertion and extraction of zinc ions in the cathode and anode electrode may lead to activation of some failure mechanisms such as fatigue, large deformation, wear, and cavitation. Similarly, mechanics (cyclic loading) may affect the kinetics of the interfacial reactions, and shape efficiency (factor) of holes in the cathode, anode, and therefore ionic transport.

The present invention is directed to the fabrication and testing of the first freeze-resistant, multifunctional quasi-solid-state zinc-sulfur battery (ZnS). To this end, an electrostatic spray coating or other techniques can be used to deposit a thin layer of sulfur on a favorable carbon substrate, including highly porous, unidirectional carbon nanofibers (A-CNFs) as a load-bearing cathode. This technique fills micro-, meso-pores, and micro-sized channels with sulfur, achieving an extensive sulfur loading of >60 wt %. Several drawbacks of hybrid supercapacitor energy storage (applicability in vaned climate conditions, poor electrochemical performance, and low failure strain) are addressed by initiating an anti-freezing hydrogel electrolyte with a failure strain of over 200%. This electrolyte possesses ethylene glycol and I₂ additive as an anti-freezing agent and redox mediator, respectively. The as-assembled ZnS battery offers a high energy density of 283 Wh/kg_{CNF-S} (191 Wh/kgz_{nS}) and mechanical properties beyond state-of-the-art structural energy storage with a tensile strength of 377 MPa, Young's modulus of 16.7 GPa. and energy-to-failure of 4.5 MJ/m³. The electro-chemo-mechanical properties of the ZnS battery were also investigated to elucidate the effects of electrochemical energy storage on mechanical properties and vise-versa. Overall, the ZnS battery outperforms state-of-the-art structural energy storage devices in terms of energy storage and load-bearing capabilities.

In addition to structural energy storage, the popularity of flexible and wearable electronic devices has created an ever-increasing demand for electrochemically-efficient flexible/stretchable energy storage devices, 3D kirigami-inspired energy storage devices have recently emerged as a viable option for achieving high strain (stretchability) without compromising electrochemical properties. However, such devices suffer from poor energy and power densities compared to those with 1D-fiber-like and 2D planar configurations.

In addition to structural storage, the quest towards stretchable electronics such as smart textiles, wearable electronics, electronic skins, lighting, displays, sensors, and wearable health monitors, has led to an ever-growing demand for stretchable and durable energy storage devices. Energy materials used in stretchable energy storage devices are required to maintain their electrochemical quality after frequently being subjected to mechanical modifications throughout thousands of cycles. These mechanical deformations may involve stretching, folding, twisting, or a combination of these. This challenge is exacerbated by taking two parameters of cost and safety into account since these stretchable energy storage devices are aimed to be mass-produced in large quantities. Stretchable supercapacitors (SCs) and batteries are the main energy supplies for stretchable and wearable electronics. Numerous stretchable batteries and SCs have been fabricated with different designs and configurations. These configurations can be categorized as 1D (fiber-like) energy storage devices (e.g., parallel fibers, twisted fibers, and core-shell fibers), 2D planar energy storage devices (sandwiches, interdigitated configurations, and arrays on chip), and 3D energy storage devices (kirigami, sponge-like and textile-like structures).

From the configuration perspective, the 1D fiber-like and 2D planar energy storage devices commonly suffer from mechanical mismatches between energy materials and substrates/gel electrolytes, resulting in a limited stretching ratio and stress concentrations, particularly at the interfaces. The poor adhesion strength between gel electrolyte and electrode causes capacitance fading and even short circuits in the case of 2D planar energy storage devices. This causes a significant drop in the electrochemical properties of stretchable 2D planar energy storage after subjecting to mechanical deformation and severely limits the performance of these devices. Furthermore, 2D devices limit the packing of parts, and thus drop the overall energy density, and they offer limited opportunities to accommodate multi-axial deformations. In contrast, methods that rely on deterministic compression-induced buckling of a construct to generate 3D devices out of an otherwise predominantly 2D structure are particularly more promising, as the device extension in the 3rd dimension enhances the device compactness, and allows a broader range of deformability. The drawbacks associated with 1D and 2D configurations, such as interface mismatch, fabrication complexity, and incompatibility with arbitrary configurations, were addressed with the introduction of 3D configuration.

3D energy storage devices have three classifications, kirigami, sponge, and textile, which are capable of omnidirectionally adjustments. While 3D kirigami/origami-inspired energy storage devices indicate pioneering alternatives for attaining high strain (stretchability) with no penalty in electrochemical properties, they suffer from low energy and power densities as compared to other configurations. While Li-based energy storage does not suffer from these drawbacks, other reasons such as being flammable raise safety concerns, considering a significant portion of the application of stretchable energy storage devices is wearable electronics or electronics that are intimately in close proximity to human subjects.

In pursuing higher energy density in a more cost-effective, non-toxic and environmentally-friendly package, metal-sulfur (M-S) batteries have been introduced as high-performance batteries. Reasons such as flammability and high (maintenance) costs are the main issues associated with lithium/sulfur and sodium/sulfur batteries in wearable electronics. Strong polarity formed by Mg2+ and Al2+ ions, which is the main reason for high energy barriers and short lifespan, restricts the applications of magnesium/sulfur and aluminum/sulfur batteries. On the contrary, the electrochemical and general attributes of zinc/sulfur (Zn—S) batteries are promising, making them a favorable candidate for the future. The high theoretical and empirical energy density (>300 W h kg−1), low cost, air compatibility, and insignificant toxicity are some examples.

Another issue with most stretchable energy storage devices with hydrogel electrolytes is the freezing of the water molecules in polymer networks under cryogenic conditions. As an anti-freezing and safe agent, ethylene glycol (EG) can be used to expand the operating temperature to subzero.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, a stretchable zinc-sulfur (ZnS) battery includes a cathode comprising a sulfur-added activated carbon (AC-S) deposited on a conductive polymer-based current collector, an anode comprising zinc nanoparticles deposited on a silver (AG)/silicone composite current collector, and a freeze-resistant hydrogel electrolyte coating disposed on the cathode and the anode.

In some aspects, the freeze-resistant hydrogel electrolyte comprises ethylene glycol.

In some aspects, the freeze-resistant hydrogel electrolyte comprises an I₂ additive.

In some aspects, a stretchable quasi-solid-state ZnS battery includes a cathode formed on a first current collector, an anode formed on a second current collector, and an anti-freezing quasi-solid hydrogel electrolyte. The stretchable quasi-solid-state ZnS battery comprises a 3D architecture comprising a shape formed by a laser-cutting process.

In some aspects, the anti-freezing quasi-solid hydrogel electrolyte is configured to withstand up to 200% strain.

In some aspects, the cathode comprises a carbon substrate that comprises a layer of sulfur.

In some aspects, the carbon substrate comprises unidirectional carbon nanofibers.

In some aspects, a current collector for a stretchable energy storage device includes a silver-filled silicone adhesive disposed between a pair of release films, and an electrostatic power coating. The current collector is subjected to a compressive stress and is partially cured.

In some aspects, the electrostatic powder coating comprises AC-S.

In some aspects, the electrostatic powder coating comprises zinc nanoparticles.

In some aspects, the current collector has an electrical conductivity of about 0.54×105 S/m.

In some aspects, a zinc particle-coated double-sided adhesive current collector, and an AC-S coated double-sided adhesive current collector. Each current collector comprises an anti-freezing quasi-solid hydrogel coating.

In some aspects, the anti-freezing quasi-solid hydrogel coating has a thickness of about 300±80 μm.

In some aspects, multiple multi-layered energy storage devices are connected in series.

In some aspects, multiple multi-layered energy storage devices are connected in parallel.

In some aspects, a method of fabricating a stretchable ZnS battery includes preparing a cathode comprising AC-S, creating a silver-filled silicone composite current collector, coating the cathode with a freeze-resistant hydrogel electrolyte, and utilizing a laser-cutting process to produce the stretchable ZnS battery with customizable shapes.

In some aspects, a conductive adhesive current collector includes a polymer-based current collector (adhesive, curable) for micro-zinc-ion hybrid supercapacitors and zinc-sulfur battery, comprising an off-the-shelf conductive adhesive ink, incorporating a thinner at a 1:1 mass ratio, and exhibiting a thickness of 10 μm or greater after spray-coating.

In some aspects, a method of preparing an activated carbon ink preparation includes mixing one of an activated carbon (AC) or an AC-S composite with a PVDF powder and dimethylformamide (DMF) to form a mixture, sonicating the mixture, and spray-coating the sonicated mixture onto a structural polyimide backing material forming a layer.

In some aspects, the layer has a total thickness of about 50-60 microns.

In some aspects, a method of scalable fabrication of MEMS ZIHSCs, the method incudes spray-coating an electrically-conductive adhesive onto a structural PET backing material, spray-coating an AC material in ink form onto the electrically-conductive adhesive, simultaneously compacting and curing the coated structural PET backing material, using electrodeposition to add Zinc nano/microplates to the cured structural PET backing material, and coating the structural PET backing material with a gel electrolyte.

In some aspects, the gel electrolyte comprises PVA/EG/Zn(CF₃SO₃)₂.

In some aspects, a method for enhancing electrical conductivity in micro-supercapacitors and zinc-sulfur battery includes hot-pressing of a current collector-activated carbon electrode assembly to form a reduced gap between particles, improved adhesion between the electrode and current collector, and an average electrical conductivity of at least 10,000 S/m.

In some aspects, a rechargeable, multifunctional quasi-solid-state ZnS battery comprising sulfur-added porous carbon substrates as the cathode material. In some aspects, the battery includes an anti-freezing hydrogel electrolyte that is fabricated both as an electrolyte and separator. In some aspects, particulate composites are adhered to a structural substrate material using a combined conductive adhesive and conductive polymer binder.

In some aspects, the electrolyte includes zinc acetate (Zn(CH₃COO)₂), ethylene glycol (EG) and iodine (I₂) additive.

In some aspects, the battery is operable over a temperature range of −25 °C to +25 °C.

In some aspects, the hydrogel electrolyte is neutral.

In some aspects, the sulfur is deposited as a thin layer on the A-CNFs and into the pores of the A-CNFs through electrostatic spray coating.

In some aspects, the porous A-CNF as sulfur substrate possesses interlayer spacing of graphitic turbostratic domains (~3.6-4.2 Å).

In some aspects, the battery includes a zinc anode.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIGS. 1A-1C show key performance parameters of three different structural energy storage devices: FIG. 1A state-of-the-art energy storage including structural batteries and energy storage. The maximum energy density reported was 45 Wh/kg; FIG. 1B overall performance of structural zinc-ion hybrid supercapacitor, in comparison, the improved batteries disclosed herein enhance the energy density to 113 Wh/kg; FIG. 1C performance of the as-fabricated ZnS battery.

FIGS. 2A-2I show: FIG. 2A charge and discharge profiles of ZnS battery in the presence of quasi-solid-state electrolyte with different zinc salts: FIG. 2B discharge profiles of ZnS battery in the presence of Zn(CH₃COO)₂—I₂/EG-based quasi-solid-state electrolyte at 25 °C; FIG. 2C charge and discharge profiles of ZnS battery with Zn(CH₃COO)₂—I₂/EG-based quasi-solid-state electrolyte at different temperatures; FIG. 2D Ragone plot (energy density vs. areal power density) for ZnS battery as compared to values reported for most efficient state-of-the-art structural energy storage; FIG. 2E the corresponding discharge rate capacities: FIG. 2F charge and discharge profiles and Coulombic efficiency of the ZnS battery at 1 A/g within the voltage window of 0.1-1.6 V; FIG. 2G XRD patterns of zinc foil before and after subjecting to 500 E-cycles; XPS spectra of (FIG. 2H) Zn 2p and (FIG. 2I) S 2p of CNF—S cathode before and after 500 E-cycles.

FIGS. 3A-3F show: FIG. 3A stress-strain curve and (inset) mechanical properties of Zn(CH₃COO)₂—I₂/EG-based quasi-solid-state electrolyte: FIG. 3B typical stress-strain plots for ZnS batteries subjected to different E-cycles from 0 to 3000 charge/discharge cycles; FIG. 3C mechanical properties (average strength, Young's modulus, and energy-to-failure) of ZnS batteries before and after E-cycles; FIG. 3D discharge profiles of ZnS battery in the presence of Zn(CH₃COO)₂—I₂/EG-based quasi-solid-state electrolyte at 25 °C as a function of number of tensile loading cycles: FIG. 3E energy density and tensile strength of ZnS battery as E- and M-cycles function; FIG. 3F energy density-tensile strength Ashby chart compares both functionalities of structural ZnS (load-bearing and energy-storing capabilities with state-of-the-art structural energy storage devices.

FIG. 4 is a schematic illustrating a scalable hybrid fabrication process of a MEMS ZIHSC.

### DETAILED DESCRIPTION

It is to be understood that the following disclosure provides many different embodiments, or examples, for implementing different features of various embodiments.

Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

An embodiment of the invention is directed to the design of a rechargeable, multifunctional quasi-solid-state ZnS battery using sulfur-added carbon substrates, including particulate and porous carbon nanofibers (CNF—S) as the cathode material. The as-fabricated ZnS outperforms state-of-the-art hybrid supercapacitor energy storage devices in terms of energy density. When constructed with porous carbon nanofibers, the device shows no evidence of fatigue failure after subjecting to mechanical and electrochemical cycling. Unidirectional highly-porous CNFs were hot-drawn to maximize the mechanical properties of the cathode materials by the alignment of turbostratic domains and changing the cylindrical shape of the pores to elliptical.

To address another drawback of structural energy storage devices, namely their applicability in varied climate conditions, an anti-freezing hydrogel electrolyte is fabricated as an electrolyte and separator. The anti-freezing hydrogel electrolyte includes zinc acetate (Zn(CH₃COO)₂), ethylene glycol (EG) and I₂ additive. I₂ and EG perform as ion carriers and anti-freezing agents, thus enhancing kinetics at different temperatures and achieving extremely high energy density. The electrochemical properties of this new generation of ZnS batteries are studied at a wide range of temperatures from −25 °C to +25 °C.

In an embodiment, CNF yarns are combined with cobalt oxide to benefit from both pseudocapacitance and double-layer energy-storing mechanisms, resulting in an energy density of 45.4 Wh/kg. To further improve the energy density, multi-functional quasi-solid-state zinc (Zn)-ion hybrid supercapacitors (ZIHSCs) were fabricated, which increased the gravimetric energy density to 113 Wh/kg. The fabricated ZIHSC showed a great combination of electrochemical and mechanical properties in a single multifunctional platform. Strength of 308 MPa, Young's modulus of 14.40 GPa, energy-to-failure of 1.82 MJ/m³, a long lifespan of over 7.500 electrochemical cycles (E-cycles), and good rate performance are all advantages of the fabricated ZIHSCs. In addition, the ZIHSC offers these electrochemical and mechanical attributes over a broad range of temperatures (−25 °C to 25 °C). In pursuing higher energy density in a more cost-effective package, introducing novel structural energy storage such as metal-sulfur (M-S) battery is extremely desirable to compete with current high-performance batteries.

In an embodiment, a particulate cathode is deposited onto an inactive structural backing material. A set of conductive adhesive and functionalized carbon-sulfur inks are applied to this structural backing material via pressurized spray. The carbon-sulfur ink that forms the anode is composed of functionalized particulate carbon substrate doped with sulfur, a conductive polymer binder, and an organic solvent. Zinc metal anode is subsequently deposited, and the anti-freezing polymer gel electrolyte is applied to seal and reinforce the material. The cathode and anode are deposited as sheets of material which can be either separated on the same layer in an interdigitated layout (two interlocking comb-like sheets), or deposited as subsequent layers that are separated in a third dimension via a layer of electrolyte material. This layer deposition process can be repeated multiple times to increase areal storage density. The resultant material is a highly resilient, flexible supercapacitor film with energy density beyond state-of-the-art. Zinc metal can be used in different configurations (series or parallel).

In an embodiment, a flexible energy storage device comprises Zn-ion hybrid MEMS supercapacitors (SCs), with high areal energy density and remarkable flexibility that allows them to bend without compromising structural integrity. Regardless of the bending degree, the Zn-ion hybrid MEMS SCs exhibit exceptional electrochemical stability. This outstanding performance positions Zn-ion hybrid MEMS SCs as promising for flexible micro-electronics. While individual supercapacitors store low energy for practical applications, combining them in series and/or parallel configurations, forming a ‘bank’ with specific voltage and capacitance ratings enhances their utility.

### Working Examples

Preparation of CNF—S cathode materials: To prepare free standing CNF—S, free standing, unidirectional and porous carbon nanofiber (P—CNF) and activated carbon nanofiber (A-CNF) were made. In short, to prepare PCNF, the polyacrylonitrile: poly(methyl methacrylate) (PAN:PMMA) emulsion was electrospun, hot drawn with a ratio of 2.5±0.2X at 135 °C stabilized at 285 °C for 2.5 h in air, and carbonized at 900 °C for 1 h under nitrogen atmosphere. The free-standing A-CNF was then transferred into a 4M KOH aqueous solution and subjected to an activation process at 1,000 °C for 1 h under nitrogen atmosphere. The activation process led to the initiation of different oxygen-containing functional groups. After washing with 3% HCl and water, and subsequent drying, the A-CNF mats were coated with a thin layer of sulfur using the electrostatic spray coating technique at a voltage range of 10-15 kV, a distance between spray gun and A-CNFs of 20 cm, and relative humidity of 40%±5%. The electrostatic spray coating was controlled by checking the mass ratio of A-CNF to sulfur and fixed at ~2:8, which was selected based on filling of the total pore volume of the A-CNFs. The sulfur-coated A-CNFs were transferred into a vacuum oven at −0.1 MPa and heated to 160 °C for 20 h.

Preparation of the anti-freezing hydrogel electrolyte: The anti-freezing hydrogel electrolyte was prepared by dissolving 4.39 g Zinc Acetate Dihydrate (Zn(CH₃CO₂)₂·2H₂O) into 10 mL water-ethylene glycol (W-EG) solution with a weight ratio of 1:2. Then, 1 g polyvinyl alcohol (PVA) was added to the solution and was stirred at 90±5 °C for 5 h. A separate solution including 21.95 mg of I₂ and 10 mL W-EG solution with weight ratio of 1:2 was prepared separately. Next, 2 ml of I₂/W-EG solution were added into the PVA/zinc acetate dihydrate/W-EG solution and was stirred at 70 °C for 24 h. The resultant viscous solution was then coated on the anode and cathode materials, sandwiched, and subjected to freeze/thaw cycles to solidify. During the freeze/thaw process, the PVA chains with 3D network (PVA crystalline domains) forms by developing intermolecular hydrogen bonds between PVA chains and H₂O and PVA chains and ethylene glycol components. The ionic conductivity of the as-prepared electrolyte is obtained to be 8.8 mS/cm.

Fabrication of ZnS batteries: To assemble ZnS batteries, both electrodes of Zn foil and CNF—S were coated with a thin layer of the anti-freezing electrolyte solution produced in section 2.2 and they were subsequently sandwiched. The as-prepared sandwich ZnS samples were immediately placed into a freezer at −25±5 °C for 1 h and thawed at room temperature for 0.5 h. Samples were subjected to 3 freeze/thaw cycles at −25±5 °C/22±5 °C to solidify the gel electrolyte. The obtained samples were sealed by embedding them into a dragon skin silicone rubber. Mechanical cycling takes a long time, and sealing can control the evaporation rate. It also minimizes the delamination failure from clamping. The mass of CNF—S mats used for electrochemical measurements was in the range of 3-7 mg. A 100 micron-thick zinc foil was used in this study; however, it is also possible to use an ultrathin zin c foil to minimize the mass associated with the anode material.

Using an electrostatic spray coating technique, a thin layer of micro-sized sulfur was initiated on the surface of the A-CNFs. Interestingly, this loading process had no significant effect on the longitudinal electrical conductivity of continuous CNF phase, reducing it only marginally from 109 S/cm to 102 S/cm. It confirmed the penetration of the sulfur into the micro-sized holes after melting. The nitrogen adsorption-desorption isotherms and differential pore volume distribution for CNF—S compared to A-CNF were observed. A-CNFs possess meso- and macro-pores with the largest N₂ uptake at P/P₀>0.5. The larger pores formed due to the decomposition of PMMA as the sacrificial agent and the smaller pores by KOH activation. The specific surface area and total pore volume of A-CNF mats are 1950 m²/g and 1.14 cm³/g, respectively. After the sulfur loading process with the electrostatic spray coating technique, the specific surface area and total pore volume dropped to 283 m²/g and 0.357 cm³/g, representing a dramatic decrease in SSA (85.5%) and total pore volume (69%), respectively. The density functional theory (DFT) model was used for the determination of the pore size distribution, illustrating a significant reduction in the pores of different sizes after sulfur loading.

Thermogravimetric analysis (TGA) results under N₂ atmosphere confirmed the sulfur loading of 60 wt. % with the electrostatic spray coating technique. The TGA/DTG curve of the A-CNFs were compared. As showed in the BET results, all pores can be filled if we reach 69.1% sulfur loading. Therefore, there is a ~9% difference between TGA and BET results, revealing the presence of some non-accessible trapped spaces (voids) for sulfur, but probably accessible for ions with considering the interlayer space between turbostratic domains. To trace the possible change in the chemical composition of sulfur after loading to A-CNFs, the S 2p XPS spectra of CNF—S and pristine sulfur with no treatment were compared, and expectedly no chemical changes in sulfur were determined after subjecting to 16 h heat treatment under vacuum conditions.

Low-resolution EDS mapping images of carbon, sulfur, and oxygen revealed homogeneous distribution of sulfur on/into the unidirectional CNFs through the electrostatic spray coating technique. This homogeneous distribution of sulfur and penetration into the micro- and meso-pores (also evidenced in BET results) minimized the induced in-plane electrical resistance by sulfur and subsequently increases the contribution of the sulfur to electrochemical reactions. Furthermore, the electrostatic spray coating technique of carbon cloth is a commercially viable process. EDS images showed that sulfur was distributed uniformly over a commercially-available hydrophobic carbon cloth with no accumulation on the surface.

Mechanical and electrochemical characterization: An Instron 5.543 single column table top tensile tester with 1 kN load cell was utilized to measure the strength and mechanical properties of ZnS. All the electrochemical tests were conducted by a CH Instrument 660E Bipotentiostat. For non-linear discharge curves, specific capacitance was calculated by Equation 1. The capacitance (Cₛₚ), capacity (Q), and efficiency (η) were obtained by applying Equations 1-3 below:

$${C}_{sp} = \frac{2 i . A {t}_{d}}{{m}_{act} \cdot Δ {V}^{2}} \qquad Equation 1$$

$$Q = {t}_{d} ( s ) \frac{i}{3.6 {m}_{act}} \qquad Equation 2$$

$$Efficiency = \frac{{t}_{d}}{{t}_{c}} \times 100 \qquad Equation 3$$

The energy density (ED) and power density (PD) were respectively calculated Equations 4 and 5 below:

$$ED = ( \frac{{C}_{sp}}{7.2} ) {( Δ V )}^{2} ( Wh / kg ) \qquad Equation 4$$

$$PD = 3600. E / Δ t ( W / kg ) \qquad Equation 5$$

In the Equations above, i is the current, m_{act} is the mass of the CNF—S electrode, t_{d} is the discharge time, t_{c} is the charge time, ΔV is the scanning potential window and A is the electrode surface area. Energy and power densities were calculated based on the total mass of the cathode material.

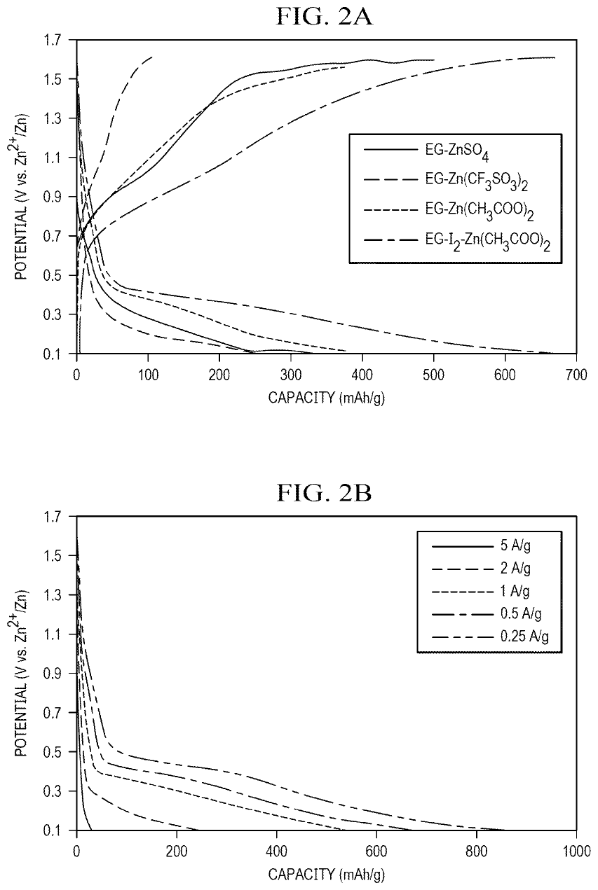

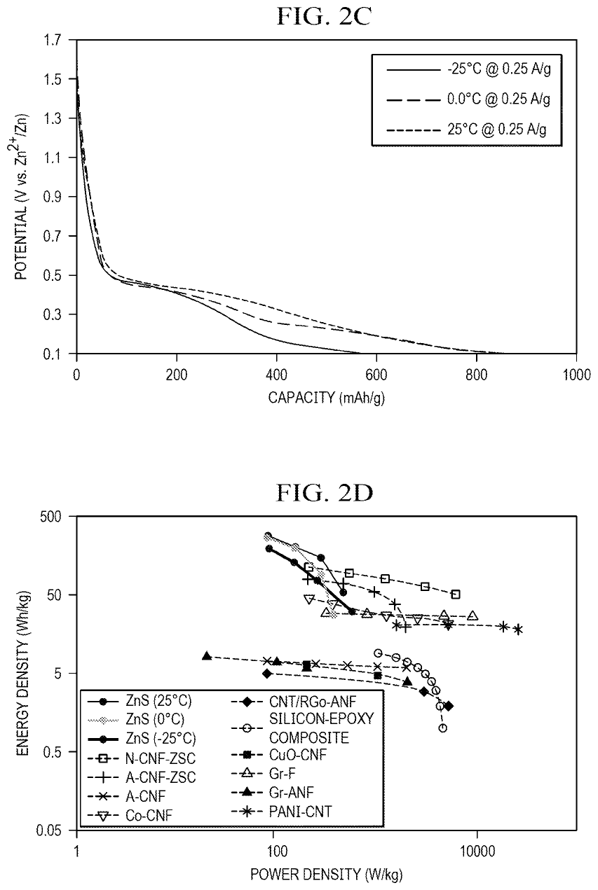

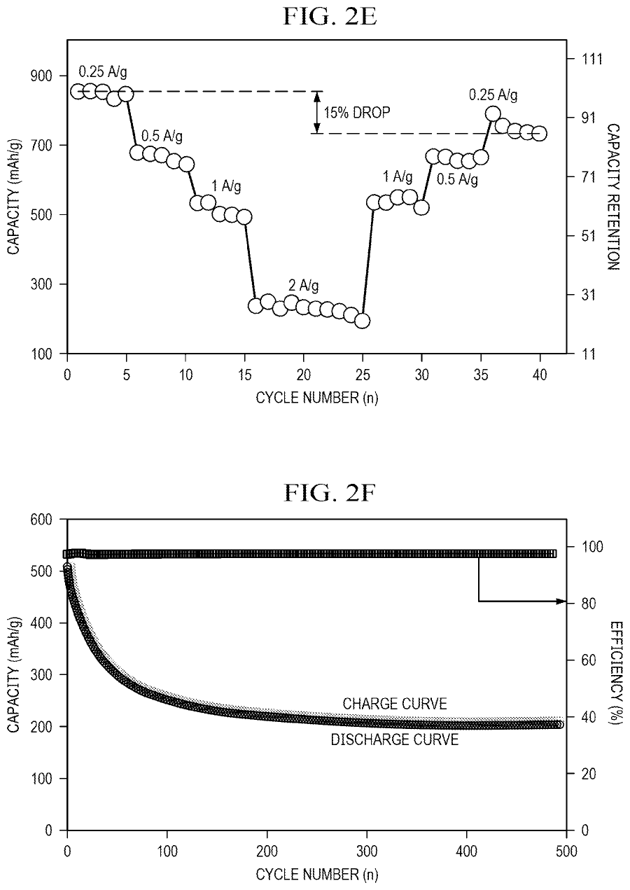

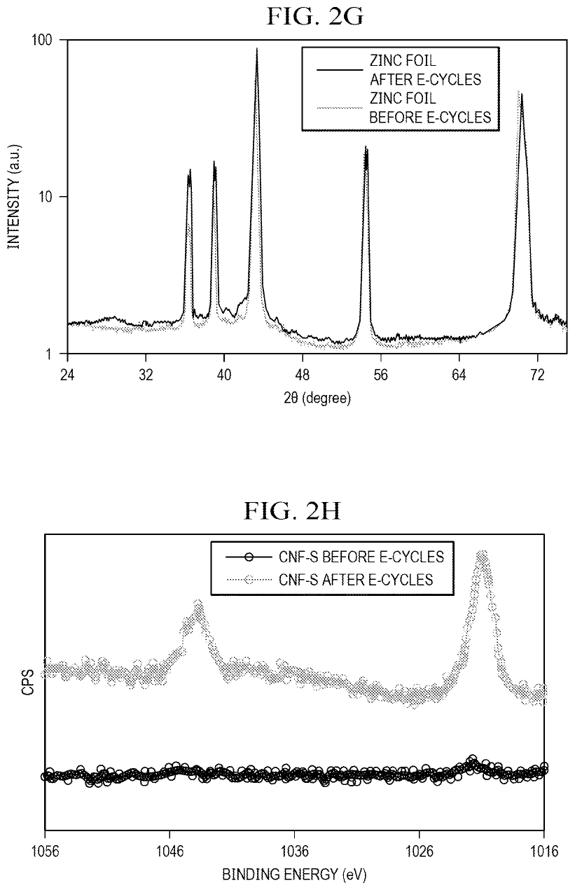

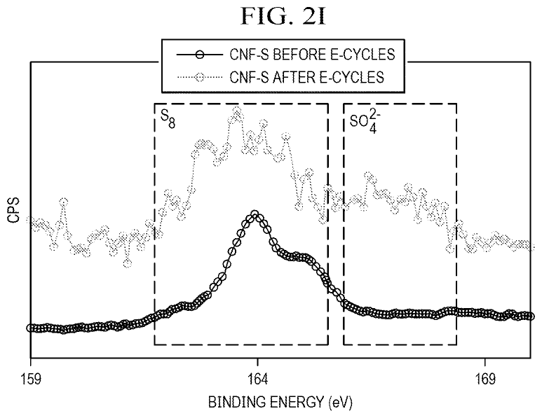

Electrochemical Results. The structural ZnS energy storage of the present invention includes an anti-freezing and robust electrolyte with proper electrochemical properties. To fabricate the electrolyte, a series of quasi-solid-state electrolytes were prepared and subjected to electrochemical measurements (FIG. 2A) to investigate the effect of zinc-ion source and anti-freezing agent on the electrochemical behavior. The experimental results showed that the ZnS battery, including the CNF—S cathode and zinc foil anode, possesses a higher discharge capacity in the presence of ZnAc (Zn(CH₃COO)₂)-based quasi-solid-state electrolyte than those of Zn(CF₃SO₃)₂ and ZnSO₄ at the same mol. %. Moreover, EG was employed as an anti-freezing agent with no adverse effect on electrochemical properties (FIG. 2A). I₂ was used as Zn²⁺ ion carrier to improve kinetics and reduce the reaction barrier. The addition of 0.1 wt % I₂ into the ZnAc (Zn(CH₃COO)₂)-based quasi-solid-state electrolyte caused a dramatic increase in discharge capacity from 375 mAh/g to 668 mAh/g at 0.5 A/g and a decrease in the voltage hysteresis in different current densities. As a redox mediator, I₂ reduces the charge polarization from about 0.4 V to 0.2 V, implying less activation energy barriers and better electrochemical properties. The galvanostatic discharge curves of the ZnS battery as a function of current density within the voltage window of 0.1-1.6 V and operational temperature of 25 °C is shown in FIG. 2B. As can be seen, the discharge curves of ZnS in the presence of ZnAc (Zn(CH₃COO)₂)-based quasi-solid-state electrolyte show one plateau that is associated with the homogeneous deposition of ZnS with small kinetic barriers, which is similar to the case of Al—S and Li—S battery. The use of I₂ reduces kinetic barriers (as the redox mediator) and extend the plateau region by serving as a Zn²⁺ ion carrier and stabilizing stripping/plating process.

To evaluate the electrochemical capability of the ZnS battery at different temperatures, the discharge curve as a function of temperature is compared in FIG. 2C at 0.25 A/g and at various current densities. Drops in discharge curve, capacity, and energy density with decreasing temperature from 25 °C to −25 °C are due to reduced segmental mobility of hydrogel chains at lower temperatures, which caused a reduction in the ionic conductivity from 8.8±0.3 mS/cm at 25 °C to 5.8±1.1 mS/cm at −25 °C. The drops in energy density and capacity for all the reported current densities were 38.3% and 41.4% on average. Even after these drops, the energy density values remain in acceptable range. The energy density of the structural ZnS battery was compared with other structural batteries, supercapacitors, and hybrid devices in the literature in a Ragone plot (FIG. 2D). The as-fabricated ZnS outperformed state-of-the-art structural energy storage in terms of energy density and showed excellent electrochemical properties in a wide range of temperatures (25 °C to −25 °C). Given the electrochemical contributions from sulfur and highly porous CNFs, the ZnS realized a maximum energy density of 283 Wh/kg (191 Wh/kg) at 25 °C, 263 Wh/kg (162 Wh/kg) at 0 °C and 193 Wh/kg (119 Wh/kg) at −25 °C based on the CNF—S cathode (based on the ZnS cell), which are one of the highest values among structural energy storage, and even zinc-selenium battery and zinc-tellurium batteries. The rate capacities and cycling performance of the structural ZnS batteries in the presence of ZnAc/I₂-based quasi-solid-state electrolytes were investigated and the results were plotted in FIGS. 2E and 2F, respectively. Unlike the majority of metal/sulfur batteries, the as-assembled structural ZnS offered an appropriate rate capability (62% on average) at the specific current range of 0.25-1.0 A/g at 25 °C. Subjecting the structural ZnS to 40 GCD cycles with different current densities caused only 15% drops in the capacity, which is a good capacity restoration for a sulfur-based battery. The formation of SO₄²⁻ and the oxygen evolution reaction (OER) are more destructive during initial cycles and it can be controlled by reducing the voltage windows, as evidenced in FIG. 2F. FIG. 2F illustrates the cycling performance of the structural ZnS battery at a current density of 1 A/g and a potential window of 0.1-1.6 V. As-fabricated ZnS offered an initial discharge capacity of 511 mAh/g at 1 A/g and decreased to 203 mAh/g after 300 cycles. Further cycles have an insignificant effect on the capacity of the ZnS batteries, and the capacity is kept steady in the successive 200 cycles. The capacity fading of the structural ZnS battery within the last 200 cycles was ~3%, which was significantly less than the initial cycles. The initial sharp capacity fading can be attributed to the sulfur side reactions, complicated oxygen and hydrogen evolution irreversible reactions, H₂S escape, disproportionation, and dissociation in the ZnS battery. Additionally, the rest of the capacity, which is almost unchangeable with electrochemical cycles (the plateau region in FIG. 2F), is attributed to the contribution of highly porous A-CNFs in energy storage. Our recent study showed that the same A-CNF in Zinc-ion hybrid supercapacitor has a promising capability in storing Zn²⁺ ions as electrode. It is well known that sulfides may easily undergo side reactions in an acidic environment. Phase equilibrium for sulfur-based battery defined by Pourbaix diagram clearly shows that the formation of SO₄²⁻ and the oxygen evolution reaction (OER) are the dominant reasons for capacity fading in high voltage. Subjecting the as-assembled ZnS to 2,000 cycles in the voltage window of 0.1-1.4 V resulted in the capacity fading of less than 5% at high current density of 5 A/g.

Appropriate electrochemical properties of as-assembled ZnS can be attributed to several factors. First, the hydrogel electrolyte is neutral, which limits the side reactions of sulfides. Second, a thin layer of sulfur deposited on the high surface area A-CNFs and into the pores through electrostatic spray coating provides an extensive interface between sulfur and the electrolyte components. Third, highly porous A-CNF as sulfur substrate possesses interlayer spacing of graphitic turbostratic domains (~3.6-4.2 Å), interconnected pores, and mesoporous multichannel, which were not entirely blocked with sulfur, facilitating ion transfer and storage. Additionally, this battery enjoys a combination of mechanisms for storing energy, which is evident from linear (EDLC and pseudocapacitance) and plateau (chemical potential) regions in the discharge profiles.

Characterization techniques such as ex-situ XPS, XRD, optical, confocal fluorescence microscopy, and SEM were used to determine the mechanisms of storing energy. The XRD patterns of the zinc foil before and after subjecting to 500 E-cycles are shown in FIG. 2G. After subjecting to 500 E-cycles, a few small peaks were added to the XRD spectra of zinc foil at the discharge point, which are in good agreement with the characterized peaks of Zn—O and partially Zn(OH)₂. Similarly, the optical microscopy and confocal fluorescence microscopy results clearly showed a dramatic increase in the roughness of the zinc anode foil after 500 cycles. The resultant micro-sized asperities in the confocal fluorescence microscopy are composed of small zinc-based sheets, which are caused by Zn²⁺ deposition/stripping. Moreover, the elemental mapping on the Zn surface clearly showed the presence of zinc and oxygen, confirming the partial oxidation of surficial Zn elements after 500 E-cycles. The formation of SO₄²⁻ ions may accelerate the formation of zinc oxide. It can dissolve in electrolyte and be the reason for minor sulfur detection on the Zn surface. Besides, the Zn2p_{3.2} spectrum of zinc anode after 500 cycles was deconvoluted by two peaks and confirmed minor oxidation. XPS was further used to identify the functional groups and elemental changes of the CNF—S electrode before and after 500 E-cycles. While Zn 2p spectra of CNF—S before subjecting it to 500 charge/discharge cycles showed no zinc peak, two sharp and broad peaks appeared at ~1,021 and 1,044 eV after 500 E-cycles in the discharged state, indicating the zinc insertion/extraction and partial zinc migration and in-situ oxidation in the presence of SO₄²⁻ ions. The significant increase of oxygen signal in EDS results complies with the appearance of a broad Zn peak in XPS results, indicating the partial oxidation of the formed zinc sheets on the surface.

In line with the sulfur-based energy storage literature and other characterization results, the S 2p spectrum of CNF—S changed significantly after subjecting to 500 E-cycles. While the S²⁻ signal was strong and evident after 500 E-cycles, a noticeable SO₄²⁻ peak at ~167 eV appeared in the S 2p spectrum (FIG. 2I), indicating the conversion of sulfur into SO₄²⁻. The formation of SO₄²⁻ can be considered as the primary deterioration mechanism for sulfur and capacity fading. Furthermore, this ion (SO₄²⁻) can easily penetrate the hydrogel and leads to further capacity fading by changing the pH1 of the electrolyte. The possible reaction mechanisms based on the above information are summarized in Table 1. Overall, the as-fabricated ZnS is a low-cost structural energy storage with extremely high energy density.

TABLE 1
Discharge and charge reactions in the ZnS battery

| | |
|---|---|
| Discharge | S + Zn²⁺ + 2e⁻ → ZnS |
| Reactions | S + Zn²⁺ + I₂ + 4e⁻ → ZnS + 2I⁻ |
| | I⁻ + I₂ → I₃⁻ |
| Charge | ZnS → S + Zn²⁺ + 2e⁻ |
| Reactions | 2ZnS + 4H₂O → S + 2Zn²⁺ + SO₄²⁻ + 8H⁺ + 10e⁻ |
| | ZnS + I₃⁻ → S + Zn²⁺ + 1.5 I₂ + 3e⁻ |
| | 2ZnS + 4H₂O + I₃⁻ → S + 2Zn²⁺ + SO₄²⁻ + +1.5 I₂ + 8H⁺ + 11e⁻ |

The degrading mechanism of ZnS during electrochemical charge-discharge cycles was also evaluated with EIS measurements. The Nyquist plots and associated equivalent circuits consist of an equivalent series resistance (Rₛ), an electrode/electrolyte interfacial resistance (Rᵢ), and charge transfer resistance (R_{ct}). The Rₛ of CNF—S cathode material increased from 7.5Ω in the 5^{th} cycle to 33.4Ω in the 500^{th} cycle and remained almost constant with electrochemical charge-discharge cycles. As Rₛ corresponds to the CNF—S′ electronic resistance, this increase can be attributed to the decoration of the cathode surface with functional groups. Interestingly, the Rᵢ resistance of CNF—S remained almost constant with electrochemical charge-discharge cycles and was negligible as compared to R_{ct}.$The R_{ct} resistance enlarges quickly during the first 200 cycles and experienced insignificant change is after 200 cycles. This increase in the Ret may associate with the development of a surficial passivated layer caused by the side reactions with the formed SO₄²⁻ ions. The stable capacity retention in the last 200 cycles in FIG. 2F can be attributed to the limitation of the side reactions.

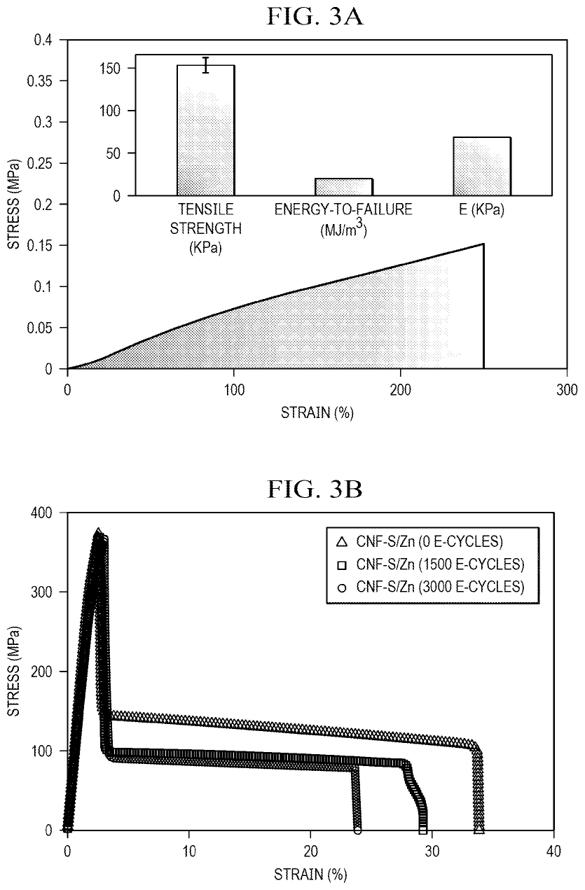

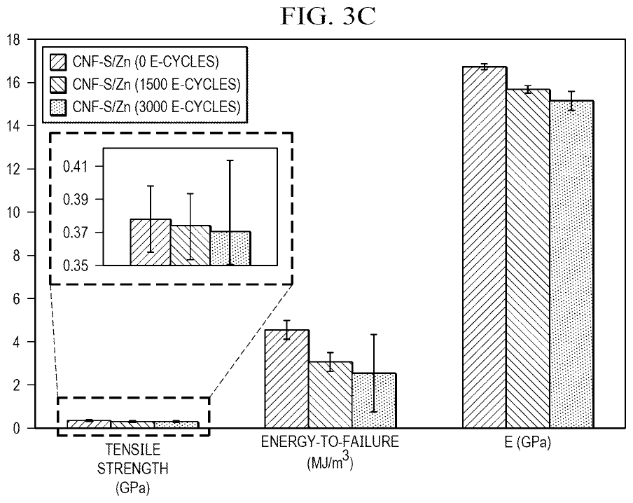

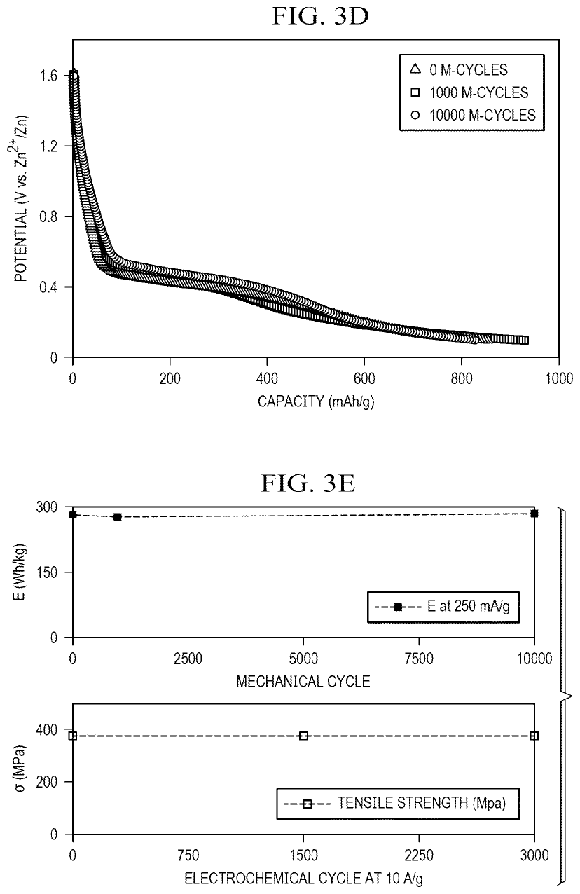

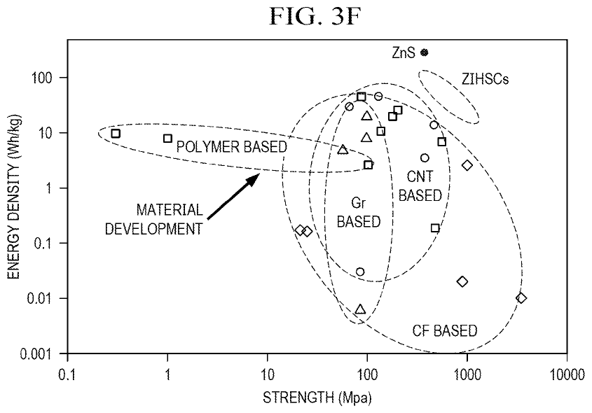

Mechanical Properties: The overall performance of structural energy storage devices is a function of its mechanical properties. ASTM D3039/D3039M-17 (for the ZnS battery including CNF—S, electrolyte and zinc foil) and D638 (for only electrolyte) were used to select the dimensions of the tensile test specimens. To this end, the mechanical properties of each component, CNF—S cathode, zinc anode, and hydrogel, were all studied to estimate the relative contribution of each component in the final sandwich structure. The comparison of the strain results between faces and core material (hydrogel electrolyte in FIG. 3A) clearly showed two orders of magnitude greater failure strain of the hydrogel electrolyte, compared to other both zinc and CNF—S electrodes. This is a property of interest since it can minimize device failure due to electrolyte delamination or rupture despite the ductility of the electrode.

The as-assembled ZnS battery was also subjected to mechanical tests under the same circumstances as its individual components. As shown in FIGS. 3B and 3C, the ZnS battery exhibited a strength of 377 MPa. Young's modulus of 16.7 GPa, and energy-to-failure of 4.5 MJ/m³ before subjecting to galvanostatic charging/discharging cycling, which is on par with the values required for typical structural materials, such as automotive composites. For continuous, unidirectional fibers and parallel to the applied load (assuming perfect alignment), the rule of mixture (the components are assumed to carry the load in parallel) can be applied to find the contributions of the CNF—S component to the tensile strength. Young's modulus in the elastic region, and energy-to-failure, which were 98%, 28%, and 44%, respectively. The tensile strength, average Young's modulus, and energy-to-failure decreased to 373 MPa (by 1%), 15.7 GPa (by 5.9%), and 3.1 MJ/m³ (by 31%) after 1500 E-cycles, and to 371 MPa (by 1.6%), 15.1 GPa (by 9.6%), and 2.5 MJ/m³ (by 44%) after 3000 E-cycles at 5 A/g. The major contribution in tensile strength was associated with CNF—S. The tensile strength of ZnS batteries showed no dramatic drop after 500 E-cycles, illustrating that the primary mechanism of the carbonaceous backbone of CNF—S is ion absorption and desorption in an electric double-layer form. Similarly, the C is spectrum of CNF—S showed no changes after E-cycles. On the contrary, the energy-to-failure strength of ZnS batteries decreased dramatically (45%) after 3000 electrochemical charge/discharge cycles, illustrating that the tough component with dominant contribution (Zn) was undergone electrochemical insertion and extraction (chemical reactions as described in Table 1), and long-term oxidation, as shown in the EDS results. Considering the highest stress in plastic region as the tensile strength of the zinc electrode, the tensile strength of zinc foil reduced from 145 MPa to 98 MPa after 1.500 cycles and to 90 MPa after 3,000 cycles. These drops in mechanical properties are attributed to zinc's electrochemical insertion and extraction during electrochemical reactions. Zinc was used during the charging/discharging cycles, and flower-like structures (zinc sheets) were formed. These flower-like structures did not contribute to load bearing. Therefore, the thinning of zinc foil and partial superficial oxidation are the main reasons for the drops in the mechanical properties.

The effect of cyclic load on the electrochemical properties of the ZnS battery was also investigated, and the results are provided in FIGS. 3D and 3E. The tensile-mode fatigue testing was performed through a cyclic load with corresponding tensile stress between 50 MPa and 300 MPa. As is clear in FIGS. 3d and 3e, the electrochemical properties (capacity and energy density) of as-assembled ZnS are not a function of loading cycles up to 10,000 mechanical cycles (M-cycles).

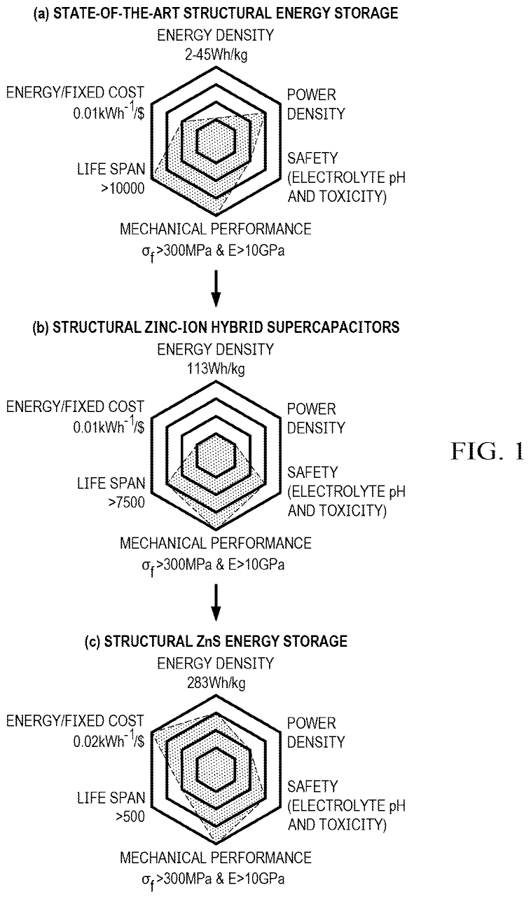

To have both mechanical and electrochemical performance in a single image and to compare the results of this study with the state-of-the-art structural energy storage solutions, an Ashby plot, including specific energy vs. tensile strength, was provided in FIG. 3F. As shown in FIG. 1, the overall performance of structural energy storage is a function of mechanical and electrochemical properties. Considering both load-bearing and energy storage functionalities as equally crucial in structural energy storage, the objective is to maximize the material index of E.σ_{f}, where E is energy density and σ_{f} is failure strength. Therefore, the best design and/or energy material must lie at the top right, where the ZnS battery is positioned, compared to state-of-the-art structural batteries and supercapacitors. From the plot, it seems that the as-assembled ZnS also outperforms all the reported structural energy storage devices in terms of both functionalities of load-bearing and energy storage. The ZnS battery could power a 1.5V electronic watch for over 5 h under cyclic load between 50 and 100 MPa (FIG. 3E), indicating the practical application for operating electronic devices.

The electrostatic spray coating technique was used for the first time to initiate a thin layer of sulfur on the continuous structural highly porous A-CNF phase. This technique was capable of filling more than 69% of the micro- and meso-scale holes generated by KOH treatment as well as micro-sized channels left from the decomposition of the PMMA in the A-CNFs. The extremely high surface area and large pore volume of A-CNFs allowed the large sulfur loading of >60 wt %, while carbon nanofibers still kept their high structural properties.

Our technique to produce sulfur-loaded structural, continuous, highly-porous CNFs as the cathode material for ZnS batteries additionally benefits from the hot drawing process of CNF precursors to maximize the mechanical properties via turbostratic alignment and changing the cylindrical shape of the pores to elliptic (oval). We also presented a facile approach to fabricate an efficient freeze-resistant hydrogel electrolyte with a failure strain of over 200% and excellent electrochemical properties in sub-freezing conditions. EG and I₂ were used as an anti-freezing agent and Zn²⁺ ion carrier to stabilize the stripping/plating process.

The structural ZnS battery, including CNF—S, freeze-resistant hydrogel electrolyte, and zinc anode, offers an energy density greater than lithium-ion batteries and mechanical properties beyond state-of-the-art structural energy storage. The as-assembled quasi-solid-state ZnS battery outperforms all the structural energy storage by delivering a maximum energy density of 283 Wh/kg, a tensile strength of 377 MPa, Young's modulus of 16.7 GPa, and energy-to-failure of 4.5 MJ/m³. The electro-chemo-mechanical properties of the ZnS battery were investigated by studying the effects of E-cycles on mechanical properties and vice-versa. It was shown that the electrochemical properties (capacity and energy density) of the as-assembled structural ZnS are not a function of loading cycles up to 10,000 cycles. The mechanical properties (tensile strength and young modulus) of the ZnS battery drop infinitesimal after subjecting to 3,000 E-cycles. Interestingly, the electrochemical insertion and extraction reactions of zinc ions have insignificant effects on the cathode material (carbon nanofiber framework).

### Stretchable Electronics

Stretchable, flexible, and anti-freezing quasi-solid-state devices can be made using ZnS batteries formed via 3D kirigami-inspired architecture. The kirigami-inspired ZnS battery includes sulfur-added activated carbon (AC-S) as the cathode material and zinc is nanoparticles (average diameter of 100 nm) as the anode-material on Ag/silicone composite current collectors. The as-prepared electrodes were subsequently coated with an anti-freezing gel electrolyte to prepare a 2D planar ZnS device and subjected to a laser-cutting process for the production of the kirigami-inspired ZnS battery with customized shapes. The as-fabricated kirigami-inspired ZnS battery was then subjected to electrochemical and mechanical tests to trace the effects of bending and stretching cycles on the electrochemical properties. The hydrogel electrolyte was synthesized to possess anti-freezing properties and make the kirigami-inspired Zn—S battery operational in a temperature range from −25 °C to +25 °C. Additionally, the stretchability and bendability of the ZnS battery have been improved by incorporating a polymer-based current collector with low electrical resistivity. The micro-sized ZnS battery with Ag/silicone composite current collectors offers an energy density of 184.8 mW h g⁻¹ based on the AC-S/Zinc NPs (67.2 mW h g⁻¹ based on the ZnS cell), deformability (strain) of 200%, a long lifespan with excellent coulombic efficiency, and a discharge capacity retention rate of 90% over 800 cycles. The stretchable Zn—S presents no electrochemical performance degradation over 10,000 cycles of stretching/releasing and an insignificant drop after 10,000 stretching/bending (180°) cycles at 25 °C. The synthesized hydrogel electrolyte endows a minor drop (<10%) in electrochemical behavior after being subjected to 10,000 stretching and bending cycles. The double-sided adhesive current collector makes it possible to fabricate multi-layered kirigami-inspired energy storage devices in serial and parallel configurations to meet stretchable electronics' energy and power requirements.

Materials and Methods: Preparation of AC-S cathode materials: The as-received activated carbon has a specific surface area of 467.5 m² g⁻¹ and a total pore volume of 0.27. To boost the specific surface area, the as-received activated carbon was double-activated by transferring it into a 6 M KOH aqueous solution, drying it at 70 °C, and subjecting it to an activation process at 1,000 °C for 1 h under a nitrogen atmosphere. The obtained sample was rinsed with 3% HCl and water, and dried. The resultant KOH-treated activated carbon was mixed with a given amount of sulfur in a 36,000 rpm-mill grinder, transferred into a vacuum oven at −0.1 MPa. and heated to 160 °C for 20 h. These conditions were kept for 20 h to give enough time to melt sulfur for diffusion into the AC. The sample was then transferred to a tube furnace and heated to 250 °C for 2 h under a nitrogen atmosphere to evaporate the excess sulfur on the outside surface of the AC. The prepared sample was deposited on the semi-cured current collector using electrostatic spray coating.

Preparation of silver-filled silicone current collector: 2 g silver-filled silicone SS-26S adhesive (purchased from Silicone Solutions) was sandwiched between two small pieces of high-temperature release film and was subjected to a compressive stress of 0.8 ton per m² by a hot press for 5±1 seconds. A thin adhesive film was kept at room temperature for 12 h to reach a partially cured state. Then, one of the release films was separated and electrostatic powder coating was utilized to coat the semi-cured adhesive with either AC-S(to prepare the current collector/cathode) or zinc nanoparticle powder (to prepare the current collector/anode). Both AC-S and zinc nanoparticles were distributed uniformly on the current collector and subjected to hot-pressing at 60 °C for 5 h. The thin film of cured silver-filled silicone adhesive possessed an average thickness of 80±20 mm and thin film electrical conductivity of 0.54×10⁵ S m⁻¹ (measured by four-point probe technique).

Preparation of anti-freezing ZnS batteries: 2.19 g zinc acetate dihydrate (ZnAc, Zn(CH₃CO₂)₂ 2H₂O) and 2.57 g zinc tetrafluoroborate hydrate (ZnBF, Zn(BF₄)₂×H₂O), and 1 g polyvinyl alcohol (PVA) were added to 8 mL water-ethylene glycol solution (weight ratio of 1:2) and stirred at 90±5 °C for 5 h (1st solution). Then, 2 mL of I₂/water-ethylene glycol solution with a weight concentration of 0.25 wt % was added to the 1^{ST} solution and stirred at 70 °C for 24 h. The resultant solution was dramatically sticky. The as-prepared electrolyte was deposited on the anode/current collector and cathode/current collector, kept under a fume hood for 24 h, sandwiched, and pressed with 4 C-clamps and subjected to 3 cycles of freeze/thaw process at −25 °C/room temperature. This freeze/thaw process causes the formation of a 3D network (PVA crystalline domains) by enabling intermolecular hydrogen bonds between PVA chains, H₂O, and ethylene glycol components. The ionic conductivity of the hydrogel was measured to have an average electrical conductivity of 7.9 mS cm⁻¹. The multi-layered sample was then cut into designed shapes using a laser cutting process to fabricate the kirigami pattern.

Results and Discussion: Electrochemical properties: To find the optimum sulfur content, the capacity and energy density of AC-S samples with different sulfur content were investigated. The capacity of the Zn—S battery decreases with sulfur content. While AC-S, with a sulfur content of 40 wt %, offered the highest capacity, the charging process suffered significantly from side reactions at the voltage range of 1.4-1.6 V. The discharge capacity decreased with the increase of sulfur content from 40 to 70 wt %, but samples with 40 wt % sulfur suffer severe side reactions at the voltage range of 1.4-1.6 V in the charging process. The formation of SO₄²⁻ can be considered as the primary deterioration reaction at the voltage range of 1.4-1.6 V. The formation of SO₄²⁻ ions accelerated at higher pH. Since the surface of the activated carbon is decorated with O—H groups, they may increase the pH of the hydrogel by penetration and lead to the formation of more SO₄²⁻ ions and a plateau curve at 1.4-1.6 V in the charging process. The higher mass ratio of AC in the cathode material intensifies this phenomenon. The electrochemical results were similar for the samples with sulfur contents of 50 wt % and 60 wt %, reaching a capacity of 707.3 mA h g⁻¹ for AC-S-50 wt % and a capacity of 675.7 mA h g⁻¹ (energy density of 184.8 mW h g⁻¹) for AC-S-60 wt %. However, the AC-S-50 wt % showed a relatively-large plateau in the charging curve, which shows the presence of partial side reactions. The capacity of the Zn—S battery deteriorated with a further increase in sulfur content, achieving a capacity of 443.6 mA h g⁻¹ and an energy density of 101.6 mW h g⁻¹ in the presence of AC-S-70 wt %. Hence, the rest of the experiments were continued with AC-S— 60 wt %.

To confirm the uniform distribution and penetration of sulfur into the pores, the AC-S-60 wt % sample was subjected to a BET (Brunauer, Emmett and Teller) test and compared with the KOH-treated AC (AC. The AC sample shows a Type I isotherm with H4 hysteresis loops, indicating microporous structure. The large uptake for the AC sample was achieved at very low partial pressures with a total pore volume of 0.739 cm³ g⁻¹. Indeed, the differential pore volume obtained by the density functional theory (DFT) model presented a large peak in the vicinity of 2 nm, an average pore size of 2.38 nm, and a high specific surface area (SSA) of 1241.6 m² g⁻¹. On the contrary, the loading of 60 wt % sulfur caused a significant drop in the SSA to 2.9 m² g⁻¹ (99.7% decrease) as well as in the total pore volume to 0.0099 cm³ g⁻¹ (98.7% decrease). Considering the sulfur density of 1.96 g cm⁻³ and the difference between the total pore volume of AC and AC-S, it can be concluded that the diffusion of sulfur into the pores was successful, and that most pores have been filled with sulfur. We further subjected the AC-S to thermogravimetry analysis (TGA) tests under N₂ atmosphere to evaluate the effect of heating process on sulfur content. The TGA results showed that AC-S undergoes two thermal degradations at 100 °C and 300 °C. The first 4% weight loss at ~100 °C can be associated with the evaporation of the absorbed water. The 2nd mass loss confirmed the sulfur content of 56 wt % for the AC-S sample.

The stretchable kirigami-inspired ZnS battery must be composed of an anti-freezing and robust electrolyte with excellent adhesiveness. To develop the proper electrolyte with good adhesion strength and electrochemical properties, we synthesized a series of is electrolytes with different zinc salts, including ZnAc, ZnBF, Zn(CF₃SO₃)₂, and ZnSO₄. A series of adhesive tensile tests were performed to investigate the effect of zinc salts on the adhesion strength by pull tests. The adhesion strength sequence in the presence of different zinc salts was Zn(CF₃SO₃)₂>ZnBF>ZnACZnBF (molar ratio of 1:1) ZnAc>ZnSO₄.

While the gel electrolytes, including ZnSO₄ or ZnAc, showed poor adhesion strength, the ZnAC-ZnBF-contained gel electrolyte exhibited a significantly higher adhesion strength of 33.5 kPa.

Although ZnAc-EG/I₂ hydrogel sample showed better electrochemical results, it suffered from poor adhesiveness and delaminated as soon as subjected to stretching/bending cycles. Both ZnBF— and Zn(CF₃SO₃)₂-EG/I₂ hydrogel electrolytes possessed excellent adhesive strength but worse electrochemical properties. To overcome this tradeoff, a combination of ZnAc and ZnBF was employed. The experimental results showed that the capacity and energy density of the electrolytes, including ZnAc: ZnBF with a molar ratio of 1:1, were higher than ZnBF and exhibited good adhesion strength. Other synthesized hydrogel electrolytes suffer from poor electrochemical properties. ZnAc-based electrolyte suffered from low adhesive strength and delaminated from bending. EG and I₂ were used as an anti-freezing agent without detrimental effects on the electrochemical properties and redox mediator, respectively. I₂ plays a role as the redox mediator by decreasing the charge polarization by 0.2 V (from 0.4 V to 0.2 V), leading to a significant drop in activation energy barriers and an improvement in the kinetics of electrochemical reactions. A remarkable increase in capacity resulted after the addition of 12, rising from 383 mA h g¹ to 675 mA h g⁻¹ at 250 mA g⁻¹. Charge and discharge profiles of the stretchable kirigami-inspired Zn—S battery at different specific currents and room temperature (25±5 °C) showed a semi-plateau region in the charge and discharge profiles that is associated with the solid-state conversion reaction of S to ZnS. A similar phenomenon was reported for other sulfur-based batteries such as Al—S and Li—S batteries. The semi-plateau region narrowed with increasing the specific density, implying slower reaction kinetics.

The electrochemical properties, e.g., energy density, power density, and capacity of the stretchable kirigami-inspired ZnS batteries were tested and compared with state-of-the-art stretchable batteries, supercapacitors, and hybrid devices. The as-fabricated stretchable Zn—S outperformed state-of-the-art kirigami-inspired energy storage in a temperature range of −25 °C to 25 °C. The stretchable ZnS battery achieved a maximum energy density of 184.8 mW h g⁻¹ based on the total mass of zinc and AC-S electrodes (67.2 mW h g⁻¹ based on the ZnS cell) at room temperature and a maximum capacity of 675.7 mA h g⁻¹, which are remarkable properties among stretchable energy storage devices with different configurations (1D fiber-like, parallel, twisted, and core-shell fibers), 2D planar (sandwiches, interdigitated configurations, and arrays on chip), and 3D (kirigami, spongelike and textile-like structures). The areal mass loading of AC-S and zinc nanoparticles was 2.6 mg cm⁻² and 3.1 mg cm⁻², respectively. The maximum areal energy density obtained for stretchable ZnS was 1.05 mW h cm⁻². The charge and discharge cycling profiles and coulombic efficiency results at 3 A g⁻¹ showed excellent electrochemical stability. The coulombic efficiency increased sharply to 96% after 50 cycles and slightly to 98% after 800 cycles. An increase in the charge transfer resistance was noticed with the number of cycles, which was associated with the development of a surficial passivated layer caused by the side reactions with the formed SO₄²⁻ ions. This passivated layer and decrease in pH due to the formation of the SO₄²⁻ ions during initial cycles. A discharge capacity retention rate of 90% was achieved after 600 cycles and was increased in the successive 200 cycles. The initial 10% capacity fading may be caused by abstruse oxygen and hydrogen evolution irreversible reactions, formation of SO₄²⁻, side reactions, disproportionation, and dissociation in the stretchable Zn—S battery.

The small difference in the capacitive behavior of the as-prepared stretchable Zn—S battery before and after subjecting to 800 electrochemical tests was investigated with impedance spectroscopy (EIS). The impedance profiles were modeled and the corresponding equivalent circuit model includes an equivalent series resistance (Rs), an electrode/electrolyte interfacial resistance (Ri), charge transfer resistance (Rct), and a Warburg diffusion resistance (W). The equivalent series resistance was raised from 7.28 U (1st cycle) to 14.16 U after subjecting to 800 cycles, which correspond to the formation of S₄²⁻ as well as subsequent side reactions on the cathode and anode surfaces. The Ri, Rct, and W resistances increased after electrochemical cycling, which is attributed to the formation of a passivated layer resulting from the side reactions with the formed SO₄²⁻ ions.

A typical EDS mapping demonstrated the presence of two elements of carbon and sulfur, which are uniformly distributed throughout the sample. The EDS images clearly show that sulfur is distributed uniformly as a thin film over the AC particles and penetrates into the holes with no accumulation on the surface.

Electro-chemo-mechanical properties: Adding kirigami patterns is beneficial in several ways, the applied strain (stress) on the structure dissipates, the strain ratio increases, is and flexibility terms such as twisting, rotation, and bending are facilitated. Charge-discharge (CD) curves demonstrated the capacitive behavior after different numbers of stretch/release cycles under 200% tensile strain at 1 A g⁻¹. The charge and discharge capacities increased with the number of cycles. The discharge capacity and energy density values were gradually increased with the number of stretch/release cycles, under 200% tensile strain. Compared to the 1st cycle, the capacity and energy density values permanently increased by 17.7% and 19.6% after 10,000 cycles. These improvements were related to the accelerated ion diffusion in the whole structure by forcing electrolyte into the pores upon stretch/release cycles. Finite Element Modeling is a viable method for performing mechanistic analysis of damage and predicting performance in failure cycles surpassing 10,000.

EIS tests were also conducted herein to elucidate changes in the capacitive behavior of ZnS batteries under 0 to 200% strain. The results showed no significant change in Rs after subjecting the stretchable Zn—S battery to different strains up to 200%.

On the contrary, Ri and Rct of the cell dropped with strain, reaching over 50% drop at 200% strain, implying a more extensive electrode/electrolyte interface. The ZnS sample began to tear at a strain of 271% and the ZnS sample failed after a couple of cycles. To ensure long-term stretching/releasing cycling, we opted to use 200% strain. So, the capacity improvement can be related to the reduction in the electrode/electrolyte interfacial and charge transfer resistances.

The stretchable kirigami-inspired ZnS battery was utilized to power a 1.5 V electronic watch under stretch/release cycles, representing an excellent energy storage alternative for the next generation of highly-flexible and stretchable electronics.

The CD curves and electrochemical properties at 1 A g⁻¹ were also examined under stretch/bending cycles (200% tensile strain and 180° bending angle). The addition of bending mode slightly degraded the capacity and energy density after subjecting the ZnS samples to 10,000 stretch/bending cycles. The maximum drop in energy density stayed at 6.3%, which could be attributed to the slight edge delamination at the electrolyte/electrode interface that was aggravated by bending stresses after each cycle. To study the effect of tensile strain on the electrochemical properties, the sample was also subjected to different strains of 0, 50, 100, 150, and 200%. The resultant discharge curves and electrochemical properties at 25 °C demonstrated that, while the capacity and energy density were relatively unchanged up to 150% (less than 2%), the increase of the strain to 200% caused an 8% increase in energy density and a 7% increase in capacity. A similar observation was reported in another study where higher capacitance was obtained by stretching the device up to 200%. The higher enlargement of the electrode-electrolyte interface, and ion diffusion, were enumerated as the reasons for higher electrochemical performance. The discharge curves and electrochemical properties were also examined at different bending angles of 0°, 60°, 90°, 120°, and 180°. The change of the bending angle at 25 °C had a negligible effect on the electrochemical properties at room temperature, indicating capacity and energy density changes of ~3%.

The electrochemical behavior of the as-assembled stretchable ZnS in different climate conditions was also studied. The electrochemical properties of ZnS batteries as a function of % strain at 0 °C and −25 °C were studied. Comparison of electrochemical results with those discussed above at 25 °C expectedly showed lower capacity and energy density at lower temperatures. The decelerations of ion diffusion and kinetics of the reactions caused at lower temperatures are the key reasons for lower electrochemical performance. The capacity and energy density were unaffected at 0 °C up to 100% strain, and the strain threshold shifted to 100%, showing a downward trend for electrochemical properties with strain % at strain levels >100%. This strain threshold was further dropped to 50% at −25 °C in a way that the capacity and energy density of the as-fabricated ZnS battery experienced 10% and 8% drops, respectively. The chain flexibility and chain mobility of hydrogel electrolytes reduced at lower temperatures, causing insignificant changes in the electrode/electrolyte interfacial and charge transfer resistances.

However, these drops were not exacerbated by subjecting the samples even to 50 stretch/release cycles of 200%. Videoclips clearly showed that the stretchable kirigami-inspired Zn—S battery preserved its stretchability at −25 f 5 °C and strain of 150% and experienced no failures/changes after subjecting to stretch/release cycles.

To study the effect of bending angle on the electrochemical properties at extreme conditions, the as-prepared ZnS battery was also subjected to different bending angles of 0°, 60°, 90°, 120°, and 180° at 0 °C and −25 °C. In addition to facing the same phenomenon, the lower the temperature, the lower the electrochemical properties, and the energy density was relatively unchanged up to 90° (less than 3%) for both temperatures. Furthermore, upon being subjected to a bending angle of 180°, the energy density exhibited a maximum decrease of 7.3%. At lower temperatures, the elasticity index values of the current collector and polymer electrolyte decreased, resulting in partial delamination. This was particularly prevalent in bending mode. Very few partial delamination sites were found, which was clearly observed in optical images. Further bending cycles at −25 °C had a negligible effect on the electrochemical properties. Cyclic voltammograms (CVs) curves of the ZnS battery at 1 mV s⁻¹ and 25 °C exhibited an asymmetrical rectangular shape with a cathodic peak potential of 0.68 V and anodic peak potential of 1.38 V, which is consistent with the GCD results obtained for the samples subjected to different strains. Furthermore, it was observed that the capacity of the ZnS battery increased with strain. A comparison of CV curves at different temperatures at a specific voltage of 1 mV s⁻¹ indicated lower capacity at lower temperatures. The entire asymmetrical rectangular shape, including cathodic and anodic peaks, exhibited a similar downward trend with temperature. This was attributed to decelerations in ion diffusion and kinetics of reactions at lower temperatures, which were identified as key reasons for lower electrochemical performance.

To meet electrochemical expectations and attributes of stretchable electronics, such as energy and power requirements, the stretchable ZnS battery with a double-sided adhesive current collector can be packaged in a straightforward manner in parallel and in series, or in a combined configuration. The electrochemical behavior of multilayered ZnS batteries was studied by assembling them in a parallel configuration and in a series configuration. A two-fold increase in the capacity and discharge time was obtained in the parallel design, as compared to a single ZnS battery at similar specific currents of 1 A g⁻¹ and 0.5 A g⁻¹. The output potential was also doubled from 1.6 V to 3.2 V in the serial design at 1 A g⁻¹ and 0.5 A g⁻¹. Considering that the area below the discharge curve was doubled, the internal resistance should be negligible, as confirmed with the EIS test, indicating the high potential of the introduced current collector and excellent conductivity at the interfaces. Further assembling of multilayered ZnS batteries in a combination of parallel and series configurations is practical and can meet the required energy and power densities for stretchable electronics.

Conclusion: The freeze-resistant, stretchable quasi-solid-state Zn—S battery holds great potential as the next generation of energy storage for stretchable electronics by addressing the critical requirements for high stretchability index, energy, and power density. The assembled ZnS battery is a multilayered package, including a zinc particle-coated double-sided adhesive current collector, an AC-S coated double-sided adhesive current collector, and an anti-freezing quasi-solid hydrogel, with ~300±80 mm thickness. The Ag/silicone current is collector composite exhibits low-electrical resistance, the possibility to use both sides, and excellent bonding to a broad range of material families after subjecting to the curing process. A simple approach was also devised to produce an efficient freeze-resistant hydrogel electrolyte with good electrochemical properties and good adhesion strength with both zinc and AC-S electrodes, including under sub-freezing conditions. EG and I₂ were respectively added to the electrolyte to act as an anti-freezing and redox mediator for stabilization of the stripping/plating process. The stretchable ZnS battery outperforms the kirigami-inspired stretchable energy storage in terms of energy density. The micro-sized ZnS battery offered a maximum energy density of 184.8 mW h g¹ (AC-S/Zinc NPs), an extended lifetime of 800 cycles with exceptional coulombic efficiency and capacity retention, and insignificant electrochemical performance degradation over stretching/releasing/bending cycles at different climates from cryogenic to ambient conditions. This technique makes it practical to fabricate multilayered kirigami-inspired energy storage devices in serial, parallel, or combined designs to deliver the high demand of energy and power for stretchable electronics.

### Zinc-Ion Hybrid Micro-Supercapacitors for Flexible and On-Chip Energy Storage

Preparation of current collector adhesive and deposition: The adhesive current collector is an off-the-shelf conductive adhesive ink available from Creative Materials. Relevant cured and uncured properties, as provided by the manufacturer, are summarized in Table 2.

TABLE 2
Material properties of the conductive
adhesive used as a current collector.

| | |
|---|---|
| Viscosity (cps) | 26,000-30,000 |
| Filler | Silver |
| Percent Filler (%) | >88 |
| Volume resistance (Ω-cm) | 0.00003 |
| Useful Temperature Range (°C) | −55 to 200 |

As-delivered, the material had an extremely high viscosity, and so a thinner was added at a ratio of 1:1 by mass to produce an ink with a viscosity in the range of 50-100 cps. Thinners include toluene, xylene, dimethylformamide (DMF), N-methylpyrrolidone (NMP) or dimethylsulfoxide (DMSO). This ink was then spray-coated using the automated machine, in 8 rapid passes. A bed temperature of 45 °C was used in order to rapidly flash off the large quantity of solvent while minimizing the heat added to the material, which is a thermosetting polymer. Measurement of samples before and after deposition of this layer demonstrates a thickness of 10±3 μm.

Preparation of activated carbon ink and spray coating: 1.8 g of the resulting activated carbon (AC) or activated carbon-sulfur composite (AC-S), 0.2 g PVDF powder was poured into a container filled with 18 g of dimethylformamide (DMF) and was sonicated by a tip-sonicator at an output power of 300 W for 0.5 hr in an ice bath.

After spray-coating a layer of electrically-conductive adhesive onto a structural polyimide backing material, which served as a current collector, the temperature of the bed increased to 80 °C and the activated carbon ink was spray coated as the second layer. This spray coating was performed in several passes to improve coating uniformity, and built to a total layer thickness of ~50-60 microns. The deposited two layers were then simultaneously compacted and cured using a hot press at 12.44 psi and 90 °C, which will improve the uniformity of the deposited material versus simply spray-coating. The areal mass-loading of the active electrode was in the range of 3.5-5 mg/cm².

Fabrication of the MEMS ZIHSCs: The fabrication process began by the masked spray coating of a layer of electrically-conductive adhesive onto a structural PET backing material, which served as a current collector. The AC material in the ink form was spray-coated and the first two layers were then simultaneously compacted and cured using a hot press at 90 °C, which further improved the uniformity of the deposited material versus only spray-coating. Following previous procedures, the thin film with an overall thickness of <70 μm was obtained. Once this refinement is complete, one set of fingers in the MEMS pattern was subjected to zinc electrodeposition to grow Zinc nano/microplates on its surface. The SC was then be further coated with a PVA/EG/Zn(CF₃SO₃) electrolyte.

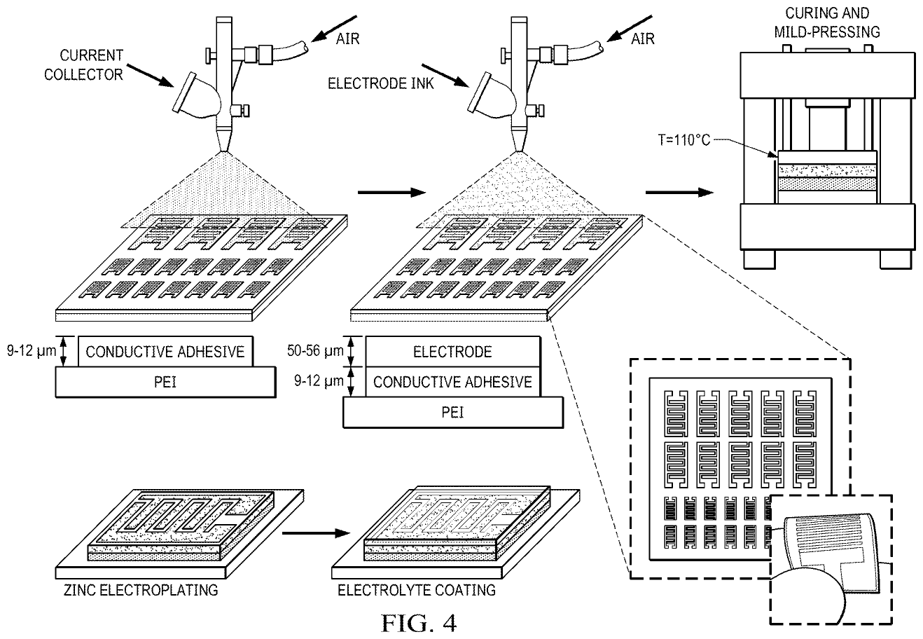

Investigation of electrical conductivity of the current collectors: The four-probe technique was used to measure the electrical conductivity of the current collector (CC) and the current collector-activated carbon electrode (CC+E). By contacting four equally-spaced of 1 cm, co-linear probes to the CC and CC+E samples, as shown schematically in FIG. 4, electrical conductivity was measured. The outer two probes were subjected to a DC current and the voltage drop between the inner two probes was measured instantaneously. Then, the obtained resistance (R=V/I) was applied in Equation 6 below to calculate the resistivity of the CC and CC+E samples.

$$ρ = \frac{π t}{ln 2} ( \frac{V}{I} ) \qquad Equation 6$$

where V, I, p, and t are the applied voltage (V), current (A), material resistivity (Ω/m), and thickness (m), respectively. Both current collector and CC+E samples are assumed to be an isotropic 2D sheet and Equation 6 was used since the space between probes was much greater than the thickness of both CC and CC+E samples. The obtained electrical conductivity for CC was 108,082 S/m (Siemens/meter), suggesting outstanding electrical properties of the deposited CC. Furthermore, after deposition of a 56-micrometer activated carbon on the current collector and hot-pressing, an average electrical conductivity of 10,689 S/m was reached, which demonstrated an excellent electrical conductivity and integrity of the electrodes. Hot-pressing (12.44 psi at 90 °C) could reduce the gap between particles and cause good adhesion between electrode and current collector, leading to good electrical properties after deposition of the electrodes.

Electrochemical Performances Analysis: The electrochemical performance of the Zn-ion hybrid MEMS supercapacitors (SCs) that were created is thoroughly examined. CV curves of the Zn-ion hybrid MEMS SCs were generated over a range of scan rates from 1 to 25 mV/s. These curves showed a quasi-rectangular shape within a voltage range of 0.2-1.8 V at lower scan rates, with minor protrusions during both cathodic and anodic sweeps, indicating the insertion and extraction of Zn-ions at the higher scan rate of 25 mV/s. The specific capacitance of Zn-ion hybrid MEMS SCs increases as the scan rates decrease, reaching its maximum value of 24.08 mF/cm² at 1 mV/s. To investigate the hybrid kinetics of the annealed hybrid MSCs, separate capacitive and diffusion currents were observed. Approximately 73.0% of the total current arises from the capacitive-controlled process at a scan rate of 25 mV/s, decreasing to 40.7% at a scan rate of t mV/s. GCD curves at various current densities (ranging from 0.5 to 10 mA/cm²) were observed and displayed a typical triangular shape indicative of capacitive and reversible electric double-layer capacitive behavior. A high areal specific capacitance of 52.16 mF/cm² was achieved at a current rate of 0.5 A/cm² The highest energy density, based on the GCD curves, was calculated to be 18.5 μWh/cm² at a current rate of 0.5 A/cm². In comparison to various high-performance micro-batteries and supercapacitors, the devices exhibited a significantly large areal energy density of 0.018 mWh/cm² at an area power density of 0.35 mW/cm² under air, surpassing other supercapacitors. Cycling stability underscores the exceptional stability of the Zn-ion hybrid MEMS SCs, maintaining approximately 95% of its initial capacitance after 9,000 galvanostatic charge/discharge cycles.

To validate the durability for flexible energy storage. Zn-ion hybrid MEMS SCs were subjected to constant strain testing. The CV performance of Zn-ion hybrid MEMS SCs under different bending conditions at 25 mV/s was observed Regardless of the bending degree, these SCs exhibited exceptional electrochemical stability, with capacity increasing by only 2% after bending to 180°. The flexibility endurance test showed a mere 2.5% increase, further supporting the device's robustness. This outstanding performance positions Zn-ion hybrid MEMS SCs as promising for flexible micro-electronics. While individual supercapacitors store low energy for practical applications, combining them in series and/or parallel configurations, forming a ‘bank’ with specific voltage and capacitance ratings enhances their utility. Zn-ion hybrid MEMS SCs demonstrate adaptability for serial/parallel combinations. The tandem devices exhibit ideal triangular charge/discharge curves with minimal voltage drop at 1 mA/cm², indicative of excellent capacitive properties and low internal resistance. In the parallel design, a two-fold increase in capacity and discharge time is observed compared to a single cell at similar specific currents of 1 mA/cm². The serial design doubled the output potential. Notably, this exceptional performance is achieved without using a voltage balance, typically required for series connections to prevent over-voltage in any cell.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood b % a person of ordinary skill in the art. In any disclosed embodiment, the terms “substantially”. “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A stretchable zinc-sulfur (ZnS) battery, comprising:
a cathode comprising a sulfur-added activated carbon (AC-S) deposited on a conductive polymer-based current collector;
an anode comprising zinc nanoparticles deposited on a silver (AG)/silicone composite current collector; and
a freeze-resistant hydrogel electrolyte coating disposed on the cathode and the anode.

2. The stretchable ZnS battery of claim 1, wherein the freeze-resistant hydrogel electrolyte comprises ethylene glycol.

3. The stretchable ZnS battery of claim 1, wherein the freeze-resistant hydrogel electrolyte comprises an I₂ additive.

4-15. (canceled)

16. A method of fabricating a stretchable ZnS battery comprising:
preparing a cathode comprising AC-S;
creating a silver-filled silicone composite current collector;
depositing zinc nanoparticles on the silver-filled silicone composite current collector;
coating the cathode with a freeze-resistant hydrogel electrolyte; and
utilizing a laser-cutting process to produce the stretchable ZnS battery with customizable shapes.

17-22. (canceled)

23. A rechargeable, multifunctional quasi-solid-state ZnS battery comprising sulfur-added porous carbon substrates as the cathode material.

24. The battery of claim 23, further comprising an anti-freezing hydrogel electrolyte that is fabricated both as an electrolyte and separator.

25. The battery of claim 23, wherein particulate composites are adhered to a structural substrate material using a combined conductive adhesive and conductive polymer binder

26. The battery of claim 23, wherein the electrolyte includes zinc acetate (Zn(CH₃COO)₂), ethylene glycol (EG) and iodine (I₂) additive.

27. The battery of claim 23, wherein the battery is operable over a temperature range of −25 °C to +25 °C.

28. The battery of claim 24, wherein the hydrogel electrolyte is neutral.

29. The battery of claim 23, wherein the sulfur is deposited as a thin layer on the A-CNFs and into the pores of the A-CNFs through electrostatic spray coating.

30. The battery of claim 29, wherein the porous A-CNF as sulfur substrate possesses interlayer spacing of graphitic turbostratic domains (~3.6-4.2 Å).

31. The battery of claim 23, further comprising a zinc anode.
